(19) United States
(12) Patent Application Publication
(10) Pub. No.: US 2010/0226839 A1
(43) Pub. Date: Sep. 9, 2010

(54) Method For Recovery of Gallium

(75) Inventors: Jian-Jou LIAN, TAINAN CITY (TW); Chung-Ching LEE, TAINAN CITY (TW); I-Wen HUANG, TAINAN CITY (TW); Hai-Jui CHEN, TAINAN CITY (TW)

Correspondence Address: BRIAN M. MCINNIS, 12th Floor, Ruttonjee House, 11 Duddell Street, Hong Kong, HK

(73) Assignee: SOLAR APPLIED MATERIALS TECHNOLOGY CORP., TAINAN CITY (TW)

(21) Appl. No.: 12/611,910

(22) Filed: Nov. 3, 2009

Related U.S. Application Data
(63) Continuation-in-part of application No. 12/397,818, filed on Mar. 4, 2009.

(51) Int. Cl. C01G 15/00

(52) U.S. Cl. 423/112

(57) ABSTRACT

The present invention provides a novel process for the removal and recovery of gallium from a feed solution containing the gallium and copper. The process of the present invention utilizes a combination of a supported liquid membrane (SLM) and a strip dispersion to improve extraction of gallium while increasing membrane stability and decreasing processing costs. This novel process selectively removes gallium from feed solution containing the gallium and copper.

### RELATED APPLICATIONS CROSS-REFERENCE TO RELATED APPLICATION

This application is a continuation-in-part of U.S. application Ser. No. 12/397,818, filed on 4 Mar. 2009, hereby incorporated by reference as it fully set forth herein.

### BACKGROUND

1. Field of Invention

The present invention relates to a method for recovery of gallium, and more particularly, to a method for removal and recovery of gallium from a feed solution containing the gallium and copper using supported liquid membrane technology.

2. Description of Related Art

Copper indium gallium diselenide (CIGS) thin film solar cells are recognized as possessing high development potential due to their high photoelectric conversion efficiency. CIGS thin film solar cells may be manufactured by vacuum sputtering, evaporation, or non-vacuum coating process. In order to reduce the cost and meet the environmental requirements, it is desired to recycle the copper, indium, gallium and selenium from the manufacturing process of CIGS thin film solar cells, regardless the way they are manufactured. Thus, there is a need in the art for removal and recovery of gallium from the waste (water).

Rafaeloff et al. (Anal. Chem. Vol. 43 No. 2 p 272-274, 1971) have described a method for recovery of gallium from a sample by extraction with 2M HCl, 1M NH₄Cl, 1M H₂SO₄ and 1M(NH₄)₂SO₄/methyl ethyl ketone and subsequent back extraction with water. The result shows that 99% of gallium together with 0.1% of copper or less than 0.01% of germanium is extracted. However, if arsenic or indium is present in the sample, 36% of arsenic or 93.6% of indium is co-extracted with gallium. It appears that gallium cannot be completely separated from arsenic and indium by the aforementioned method. Furthermore, methyl ethyl ketone is highly explosive due to the low boiling point thereof and needs to be replenished frequently due to the high volatility thereof thereby increasing cost.

Nishihama et al. (Syouhei Nishihama, “Separation and Recovery of Gallium and Indium from Simulated Zinc Refinery by Liquid-Liquid Extraction” Ind. Eng. Chem. Res. 1999, 38, 1032-1039) have disclosed a gallium recovery method accomplished by mixing and separating in a continuous strip system (liquid-liquid extraction). Nishihama et al. directly mixed an organic extractant such as D2EHPA with an aqueous feed solution and employed hydrochloric acid as the strip dispersion. However, emulsion is often formed in this method thereby decreasing the recovery rate and increasing the consumption of the extractant.

Liquid membrane technologies combine extraction and stripping, which are normally carried out in two separate steps in the conventional recovery methods described above, into one step. A one-step liquid membrane process provides the maximum driving force for the separation of a targeted species, leading to the best clean-up and recovery of the species (W. S. Winston Ho, “Combined Supported Liquid Membrane/Strip Dispersion Process for the Removal and Recovery of Metals”, U.S. Pat. No. 6,350,419 (2002)).

There are two types of liquid membranes: (1) supported liquid membranes (SLMs) and (2) emulsion liquid membranes (ELMS). In SLMs, the liquid membrane phase is the organic liquid imbedded in pores of a microporous support, e.g., microporous polypropylene hollow fibers (W. S. Winston Ho, “Combined Supported Liquid Membrane/Strip Dispersion Process for the Removal and Recovery of Metals”, U.S. Pat. No. 6,350,419 (2002)). When the organic liquid contacts the microporous support, it readily wets the pores of the support, and the SLM is formed.

SLMs have been investigated to remove metals, radionuclides, and rare earth metals from aqueous feed solutions in the scientific and industrial community. The removal of metals, including copper, zinc, cadmium, and palladium, with SLMs has been described.

Chun-Hua Cui et al. (Chun-Hua Cui, Zhong-Qi Ren, Wei-Dong Zhang, Yan-Qiang Yang, Zi-Su Hao, “Treatment of Wastewater Containing Copper(II) Using Hollow Fiber Supported Liquid Membrane Technique” (J. Chem. Eng. Chin. Univ. 2008, 22(4))) have described the use of a hollow fiber module soaked in a kerosene solution containing 10% di(2-ethyl-hexyl)phosphoric acid (D2EHPA) for at least 48 hours thereby forming a D2EHPA/Kerosene liquid membrane phase in the pores of the hollow fiber module. In addition, CuSO₄ aqueous solution (pH 4.44) was used as simulated industrial wastewater, and HCl aqueous solution was used as stripping (receiver) phase.

One disadvantage of SLMs is their instability due mainly to loss of the membrane liquid (organic solvent, extractant, and/or modifier) into the aqueous phases on each side of the membrane (A. J. B. Kemperman, D. Bargeman, Th. Van Den Boomgaard, H. Strathmann, “Stability of Supported Liquid Membranes: State of the Art”, Sep. Sci. Technol., 31, 2733 (1996); T. M. Dreher and G. W Stevens, “Instability Mechanisms of Supported Liquid Membranes”, Sep. Sci. Technol., 33, 835-853 (1998); J. F. Dozol, J. Casas, and A. Sastre, “Stability of Flat Sheet Supported Liquid Membranes in the Transport of Radionuclides from Reprocessing Concentrate Solutions”, J. Membrane Sci., 82, 237-246 (1993)).

Ho has described an extraction process which maximizes the stability of the SLM membrane, resulting in efficient removal and recovery of metals, radionuclides, penicillin, and organic acids from the aqueous feed solutions. Ho recognized the need and invented the combined supported liquid membrane/strip dispersion process for the removal of chromium (W. S. Winston Ho, “Supported Liquid Membrane Process for Chromium Removal and Recovery”, U.S. Pat. No. 6,171,563 (2001)), metals (W. S. Winston Ho, “Combined Supported Liquid Membrane/Strip Dispersion Process for the Removal and Recovery of Radionuclides and Metals”, U.S. Pat. No. 6,328,782 (2001); W. S. Winston Ho, “Combined Supported Liquid Membrane/Strip Dispersion Process for the Removal and Recovery of Metals”, U.S. Pat. No. 6,350,419 (2002)), radionuclides (W. S. Winston Ho, “Combined Supported Liquid Membrane/Strip Dispersion Process for the Removal and Recovery of Radionuclides and Metals”, U.S. Pat. No. 6,328,782 (2001); W. S. Winston Ho, “Combined Supported Liquid Membrane/Strip Dispersion Process for the Removal and Recovery of Radionuclides”, U.S. Pat. No. 6,696,589 (2004)), and penicillin and organic acids (W. S. Winston Ho, “Combined Supported Liquid Membrane/Strip Dispersion Process for the Removal and Recovery of Penicillin and Organic Acids”, U.S. Pat. No. 6,433,163 (2002)). The synthesis of dialkyl monothiophosphoric acid extractants for the combined supported liquid membrane/strip dispersion process for the removal of metals has been reported (W. S. Winston Ho and Bing Wang, “Combined Supported Liquid Membrane/Strip Dispersion Process for the Removal and Recovery of Metals: Dialkyl Monothiophosphoric Acids and Their Use as Extractants”, U.S. Pat. No. 6,291,705 (2001)).

However, none of these prior arts disclose the use of the combined supported liquid membrane/strip dispersion process for the removal and recovery of gallium from a feed solution containing the gallium and copper.

Thus, there is a need in the art for an extraction process which enhances the stability and efficiency of the SLM membrane for the removal and recovery of gallium from the aqueous feed solutions.

### SUMMARY

The present invention relates to a method for the removal and recovery of gallium from a feed solution containing the gallium and copper.

In one embodiment, the present invention relates to a method which comprises the following steps. First, a supported liquid membrane (SLM) embedded in a microporous support material is provided, and a strip dispersion by dispersing an aqueous strip solution in an organic liquid comprising an extractant is provided. Then, the initial pH value of the feed solution is adjusted to at most 3.5, or a concentrated acid is added to the feed solution such that the initial concentration of the acid in the feed solution is at least 10N. The feed solution containing copper and gallium is treated on one side of the SLM to selectively remove the gallium by the use of the strip dispersion on the other side of the SLM. The strip dispersion or a part of the strip dispersion is separated into an organic liquid phase and an aqueous strip solution phase, the aqueous strip solution phase containing a concentrated gallium solution.

According to one embodiment of the present invention, the microporous support material is a hollow fiber module comprising microporous hollow fibers arranged in a shell-and-tube configuration, the feed solution containing the gallium and copper is passed through the tube side of the hollow fiber module, and the strip dispersion is passed through the shell side of the hollow fiber to module.

According to another embodiment of the present invention, the feed solution further comprises indium (In) and is added with the concentrated acid such that the initial concentration of the acid in the feed solution is at least 10N.

According to another embodiment of the present invention, the initial pH value of the feed solution is adjusted to the range between 0.5 and 1.5.

The methods disclosed by the embodiments of the present invention provide a number of advantages over the use of conventional SLMs or solvent extraction. The methods use combined supported liquid membrane (SLM) and strip dispersion for the removal and recovery of gallium thereby avoiding emulsion formed in conventional methods of direct extraction of gallium wherein the emulsion decreases the recovery rate and increases the consumption of the extractant.

The combined supported liquid membrane (SLM)/strip dispersion process for the removal and recovery of gallium from a feed solution disclosed by the embodiments of the present invention is a liquid membrane separation which combines extraction and stripping into one continuous step. Compared with other processes, the methods of the present invention significantly save manpower, improve the gallium recovery rate to at least 99% and eliminate the need for a extra concentration step.

### BRIEF DESCRIPTION OF THE DRAWINGS

The invention can be more fully understood by reading the following detailed description of the embodiment, with reference made to the accompanying drawings as follows:

FIG. 1 is a schematic representation of the combined supported liquid membrane/strip dispersion of the present invention for the recovery of gallium; and

FIG. 2 is an enlarged view of the schematic representation of the combined supported liquid membrane/strip dispersion of the present invention is for the recovery of gallium.

### DETAILED DESCRIPTION

The present invention relates to a method for the removal and recovery of gallium from a feed solution containing the gallium and copper. The method employs a combination of a supported liquid membrane (SLM) and a strip dispersion. Suitable feed solutions include, but are not limited to, wastewaters or process streams.

In one embodiment, the present invention relates to a method for the removal and recovery of gallium from a feed solution containing the gallium and copper. The method includes the following steps. First, a supported liquid membrane (SLM) embedded in a microporous support material is provided, and a strip dispersion by dispersing an acidic strip solution in an organic liquid comprising an extractant is provided. Then, the initial pH value of the feed solution is adjusted to at most 3.5, or a concentrated acid is added to the feed solution such that the initial concentration of the acid in the feed solution is at least 10N. Thereafter, the resulted feed solution is passed on one side of the SLM and treated to remove the gallium by the use of the strip dispersion on the other side of the SLM. Second, the strip dispersion or a part of the strip dispersion, is allowed to stand, resulting in separation of the strip dispersion into an organic liquid phase and an aqueous strip solution phase wherein the aqueous strip solution phase contains a concentrated gallium solution. The adjusted initial pH value of the feed solution resulted from the pH-adjusting step will be varied with time as the recovery process proceeds. Similarly, the initial concentration of the acid contained in the feed solution resulted from the concentrated acid-adding step will be varied with time as the recovery process proceeds.

In some embodiments, the initial pH value of a feed solution containing the gallium and copper is adjusted to the range between 0.5 and 1.5 thereby further improving the recovery rate of gallium.

In some embodiments, the volume of the organic liquid is larger than the volume of the aqueous strip solution in the strip dispersion. In certain embodiments, the volume ratio of the organic liquid to the aqueous strip solution in the strip dispersion is about 2:1.

It is noted that if the initial pH value of the feed solution containing the gallium and copper exceeds 3.5, the gallium will start to precipitate in the feed solution and cannot be removed and recovered via the aforementioned method.

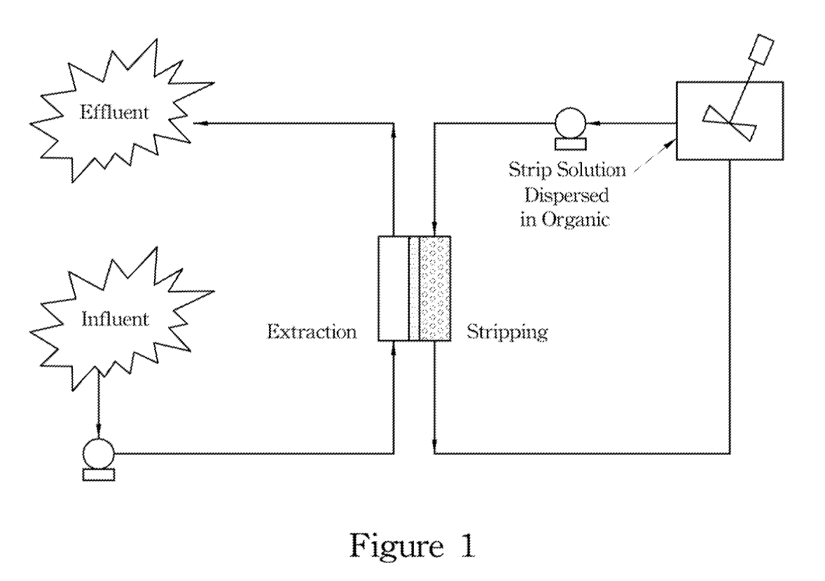

While any SLM configuration may be employed in the method of the invention, one configuration employs a hollow fiber module as the liquid membrane microporous support. Such hollow fiber modules consist of microporous hollow fibers arranged in a shell-and-tube configuration. In the present invention, the strip dispersion is passed through either the shell side of the module or the tube side of the module, and the aqueous feed solution containing gallium for extraction is passed through the opposing side of the module. The use of the hollow fiber system in the combined SLM/strip dispersion process allows constant supply of the strip dispersion as shown in FIG. 1, ensuring a stable and continuous operation.

In one embodiment, the feed solution is passed through the tube side of is the module, and the strip dispersion is passed through the shell side of the module. In another embodiment, the feed solution and the strip dispersion flow in a countercurrent mode in the hollow fiber module, i.e. the strip dispersion passes through the shell side in a countercurrent direction to the flow of the feed solution passing through the tube side such that the contact time between the feed solution and the strip dispersion becomes longer for improving the extraction efficiency.

For the purposes of the invention, strip dispersion is defined as a mixture of an aqueous phase and an organic phase. The aqueous phase of the strip dispersion comprises an aqueous strip solution, while the organic phase comprises an extractant or more than one extractant. The strip dispersion is formed by the mixing of the aqueous and organic phases as shown in FIG. 1. This combination results in droplets of the aqueous strip solution in a continuous organic phase. The dispersion is maintained during the extraction process due to the flow of the dispersion through a membrane module, e.g., a hollow-fiber module. The continuous organic phase of the strip dispersion readily wets the hydrophobic pores of the microporous hollow fibers in the module, forming a stable liquid membrane.

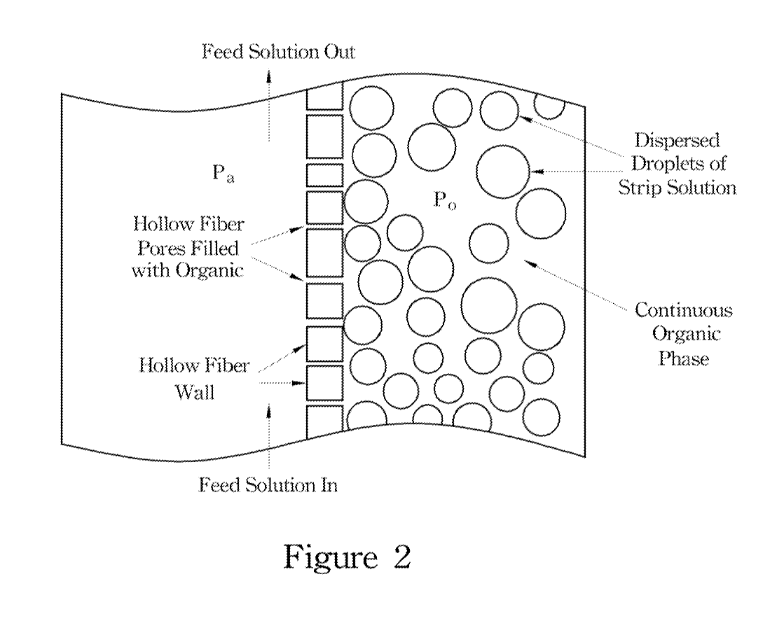

FIG. 2 shows an enlarged view of a schematic representation of the SLM with strip dispersion of the present invention. A low pressure, Pa, which is typically less than approximately 2 psi, is applied on the feed solution side of the SLM. The pressure Pa is greater than the pressure, Po, on the strip dispersion side of the SLM. This difference in pressure prevents the organic solution of the strip dispersion from passing through the pores to come into the feed solution side. The dispersed droplets of the aqueous strip solution in a typical size of about 80 to about 800 micrometers and are orders of magnitude larger than the pore size of the microporous support employed for the SLM, which is in the order of approximately 0.03 micrometer. Thus, these droplets are retained on the strip dispersion side of the SLM and cannot pass through the pores to go to the feed solution side.

In this SLM/strip dispersion system, there is a constant supply of the organic membrane solution, i.e., the organic phase of the strip dispersion, into the pores. This constant supply of the organic phase ensures a stable and continuous operation of the SLM. In addition, the direct contact between the organic and strip phases provides efficient mass transfer for stripping. The organic and strip phases can be mixed, for example, with high-shear mixing, to increase the contact area between the two phases.

Once removal of gallium is complete, the mixer for the strip dispersion is stopped, and the dispersion is allowed to stand until it separates into two phases, the organic membrane solution and the concentrated strip solution. The concentrated strip solution containing gallium is the product of this process.

The feed solution includes, but is not limited to, waste waters or process streams containing gallium. In one embodiment, the feed solution containing the gallium and copper may be a solution obtained by dissolving a Cu/Ga spent target in an acid. In other embodiments, the feed solution may further includes indium, such as a solution obtained by dissolving a Cu/In/Ga spent target in an acid. The feed solution containing Cu/In/Ga is added with a concentrated acid (such as concentrated hydrochloric acid) such that the initial concentration of the acid in the feed solution is at least 10N.

The microporous support employed in the invention is comprised of, for example, microporous polypropylene, polytetrafluoroethylene, polyethylene, polysulfone, polyethersulfone, polyetheretherketone, polyimide, polyamide, polyaramide, or mixtures thereof. The preferred microporous supports are microporous polypropylene and polytetrafluoroethylene hollow fibers.

The aqueous portion of the strip dispersion comprises an aqueous acid solution. Acids appropriately used in the present invention include, but are not limited to, hydrochloric acid (HCl), sulfuric acid (H₂SO₄), nitric acid (HNO₃), and acetic acid (CH₃COOH). The acid is present in a concentration between 0.1M and 18M. The preferred concentration for the acid solution is between 1 M and 6 M.

The continuous organic liquid phase into which the aqueous strip solution is dispersed contains an extractant or more than one extractant. The extractant is capable of extracting gallium contained in the feed solution.

The organic liquid of the present strip dispersion optionally comprises a hydrocarbon solvent or mixture. The hydrocarbon solvent or mixture has a number of carbon atoms per solvent molecule ranging from 6 to 18, preferably from 10 to 14. The hydrocarbon solvent includes, for example, n-decane, n-undecane, n-dodecane, n-tridecane, n-tetradecane, isodecane, isoundecane, isododecane, isotridecane, isotetradecane, isoparaffinic hydrocarbon solvent (with a flash point of 92° C., a boiling point of 254° C., a viscosity of 3 cp (at 25° C.), and a density of 0.791 g/ml (at 15.6° C.)) or mixtures thereof.

The organic liquid of the present strip dispersion for recovery of gallium comprises about 10% by volume to about 70% by volume D2EHPA (di(2-ethyl-hexyl)phosphoric acid). In some embodiments, the organic liquid for recovery of gallium comprises about 30% by volume to about 70% by volume D2EHPA. In certain embodiments, the organic liquid for recovery of gallium comprises about 30% by volume to about 50% by volume D2EHPA (di(2-ethyl-hexyl)phosphoric acid).

The present invention has several advantages over conventional SLM technology for removal and recovery of gallium from aqueous feed solution. These advantages include increased membrane stability, reduced costs, increased simplicity of operation, improved flux, and improved recovery for gallium.

The present invention provides a constant supply of the organic membrane solution into the pores of the hollow fiber support for removal and recovery of gallium from aqueous feed solution. This constant supply results in an SLM which is more stable than conventional SLMs, ensuring stable and continuous operation. This constant supply also eliminates the need for recharging membrane modules, which is required with conventional SLMs. Further, it eliminates the need for a second set of membrane modules for use during recharging of the first set of membrane modules. Thus, the present invention decreases not only operational costs but also the initial capital investment in the system. The present invention also increases simplicity of the removal operation.

The present invention provides direct contact between the organic/extraction phase and aqueous strip phase. Mixing of these phases provides an extra mass transfer surface area in addition to the area given by the hollow fibers, leading to extremely efficient stripping of the target species from the organic phase. This efficient stripping enhances the flux for the extraction of gallium.

In some embodiments, the methods of the present invention are suitable for recovering gallium from a feed solution containing copper (or indium) with a higher concentration than the gallium. However, in other embodiments, the methods of the present invention are also suitable for recovering gallium from a feed solution containing copper (or indium) with a lower concentration than the gallium. Although the following specific examples are illustrated as recovering gallium from a feed solution containing copper (or indium) with a higher concentration than the gallium, they are used to show the excellent capability of the present invention in the highly selective recovery of gallium from the feed solution.

This invention is further illustrated by the following examples, which are not to be construed in any way as imposing limitations upon the scope thereof. To the contrary, it is to be clearly understood that reading the description herein may suggest various other embodiments, modifications, and equivalents to those skilled in the art without departing from the spirit of the present invention and/or the scope of the appended claims.

### EXAMPLES

### General Procedure

In all of the following examples, the supported liquid membranes (SLMs) with strip dispersion were used to extract gallium from an aqueous feed solution to an organic solution, in which an aqueous strip solution was dispersed to continually strip the extracted gallium. The SLM system consisted of a hollow-fiber membrane module (Liquid-Cel®, extra-flow 2.5×8, Membrana-Charlotte, USA), a feed solution tank, a feed pump (model 7592-50, is Cole-Parmer, USA) to drive the feed solution into the polypropylene hollow fibers in the module, a strip dispersion tank with a mixer (SS-NZ-1000, Eyela, Japan) to well disperse the aqueous strip solution in the organic solution, and another pump (model 7553-70, Cole-Parmer, USA) to drive the water-in-oil dispersion into the shell side of the module. The hollow-fiber module was 6.35 cm (2.5 inches) in diameter and 20.3 cm (8 inches) in length, and it had a membrane surface area of 1.4 m².

All of the following examples were run in the countercurrent mode with the feed solution passing through the tube side of the microporous polypropylene hollow fiber module whereas the strip dispersion passing through the shell side of the module. Gallium in the feed solution was extracted to the organic solution in the membrane module, and the extracted gallium was stripped into the dispersed strip solution both in the module and in the dispersion tank.

The aqueous feed solution, containing gallium, was placed in the feed tank that was agitated by a magnetic stirring bar at a rate of 300 rpm. The strip solution, HCl aqueous solution, was dispersed with a 2-bladed paddle (8.5 cm in diameter) at a rate of 300 rpm in the organic solution containing D2EHPA (Merck) as the extractant for gallium in isoparaffinic solvent which is to commercialized under the brand name “™” (Shell)

The volume ratio of the organic liquid to the aqueous strip dispersion is 2:1 unless specified otherwise in the following examples.

The process was first started by passing the feed solution through the tube side of the hollow fiber module. After the hollow fibers were filled with the feed solution, the water-in-oil dispersion was pumped into the shell side of the module. To prevent the organic phase form passing through the pores of the hollow fibers into the feed solution, the pressure in the tube side was maintained at a positive pressure, i.e., 4-5 psi higher than that in the shell side unless specified otherwise. Both the feed and dispersion solutions were pumped from the tanks to the module and then recycled back to the tanks. The pumping rate for both streams was kept at 1 L/min.

During each embodiment, samples from the feed and strip solutions were taken at certain timed intervals. The strip dispersion samples were allowed to stand until phase separation occurred. The aqueous phase from the strip dispersion sample was then collected. The aqueous phase samples from the strip dispersion samples and the feed solution samples were then analyzed to determine the gallium concentrations by using an atomic absorption spectrophotometer (GBC 906, GBC, Australia) unless specified otherwise (for example, using an inductively coupled plasma (ICP) spectrometer).

Experiments with different feed compositions and volumes were carried out to investigate the performance of the process of SLM with strip dispersion.

The performance maybe expressed in terms of gallium recovery and concentrations in both the treated feed and strip solutions.

### Example 1

Feed Solution (1 L) containing 4.5 wt % of copper and 1.5 wt % of gallium and being adjusted to an initial pH value of 0.5 by adding sodium hydroxide (NaOH)

Organic Solution=10% by volume D2EHPA in Isoparaffinic Solvent™, is 1 L

Strip=1N HCl, 0.5 L

The strip dispersion is produced as described in the general procedure above.

The feed solution containing about 4.5 wt % Cu²⁺ and 1.5 wt % Ga³⁺ was pumped into the tube side of the polypropylene hollow fiber module. The strip dispersion was fed into the shell side of the hollow fiber module. Samples of the feed and strip solutions were collected at certain timed intervals as described in the general procedure above and analyzed by atomic absorption spectrophotometry.

The procedure was stopped until the gallium concentration in the feed solution is less than 30 ppm, and the strip dispersion was drained from the shell side of the hollow fiber module into a collection tank. The strip dispersion was allowed to stand until phase separation occurred. The aqueous solution phase, i.e., the concentrated gallium solution, was collected. The gallium concentration after recovery was measured as about 3 wt %. The gallium recovery rate was calculated to be about 99.3%, and the copper removal rate was calculated to be about 99.7%. The collected solution was electrolyzed to obtain high purity gallium metal (>4N).

### Example 2

Feed Solution (1 L) containing 4.5 wt % of copper and 1.5 wt % of gallium and being adjusted to an initial pH value of 1 by adding sodium hydroxide (NaOH)

Organic Solution=10% by volume D2EHPA, in Isoparaffinic Solvent™, 1 L

Strip=1N HCl, 0.5 L

The experimental procedure for this example was the same as that described in Example 1 except that the feed solution was adjusted to have an initial pH value of 1 instead of 0.5 by adding sodium hydroxide.

The procedure was stopped until the gallium concentration in the feed solution was less than 30 ppm, and the strip dispersion was drained from the shell side of the hollow fiber module into a collection tank. The strip dispersion was allowed to stand until phase separation occurred. The aqueous solution phase, i.e., the concentrated gallium solution, was collected. The gallium concentration after recovery was measured as about 3 wt %. The gallium recovery rate was calculated to be about 99.3%, and the copper removal rate was calculated to be about 99.7%. The collected solution was electrolyzed to obtain high purity gallium metal (>4N).

### Example 3

Feed Solution (1 L) containing 4.5 wt % of copper and 1.5 wt % of gallium and being adjusted to an initial pH value of 1.5 by adding sodium hydroxide (NaOH)

Organic Solution=10% by volume D2EHPA, in Isoparaffinic Solvent™, 1 L

Strip=1N HCl, 0.5 L

The experimental procedure for this example was the same as that is described in Example 1 except that the feed solution was adjusted to an initial pH value of 1.5 instead of 0.5 by adding sodium hydroxide.

The procedure was stopped until the gallium concentration in the feed solution was less than 30 ppm, and the strip dispersion was drained from the shell side of the hollow fiber module into a collection tank. The strip dispersion was allowed to stand until phase separation occurred. The aqueous solution phase, i.e., the concentrated gallium solution, was collected. The gallium concentration after recovery was measured as about 3 wt %. The gallium recovery rate was calculated to be about 99.3%, and the copper removal rate was calculated to be about 99.7%. The collected solution was electrolyzed to obtain high purity gallium metal (>4N).

### Example 4

Feed Solution (1 L) containing 4.5 wt % of copper and 1.5 wt % of gallium and being adjusted to an initial pH value of 1 by adding sodium hydroxide (NaOH)

Organic Solution=30% by volume D2EHPA, in Isoparaffinic Solvent™, 1 L

Strip=3N HCl, 0.5 L

The experimental procedure for this example was the same as that described in Example 1 except that the feed solution was adjusted to an initial pH value of 1 instead of 0.5 by adding sodium hydroxide, and 30 vol % D2EHPA was used instead of 10 vol %, and 3N HCl was used instead of 1N.

The procedure was stopped until the gallium concentration in the feed solution was less than 30 ppm, and the strip dispersion was drained from the shell side of the hollow fiber module into a collection tank. The strip dispersion was allowed to stand until phase separation occurred. The aqueous solution phase, i.e., the concentrated gallium solution, was collected. The gallium concentration after recovery was measured as about 3 wt %. The gallium recovery rate was calculated to be about 99.5%, and the copper removal rate was calculated to be about 99.2%. The collected solution was electrolyzed to obtain high purity gallium metal (>4N).

### Example 5

Feed Solution (1 L) containing 4.5 wt % of copper and 1.5 wt % of gallium and being adjusted to an initial pH value of 1 by adding sodium hydroxide (NaOH)

Organic Solution=50% by volume D2EHPA, in Isoparaffinic Solvent™, 1 L

Strip=3N HCl, 0.5 L

The experimental procedure for this example was the same as that described in Example 4 except that the 50 vol % D2EHPA was used instead of 30 vol %.

The procedure was stopped until the gallium concentration in the feed solution is less than 30 ppm, and the strip dispersion was drained from the shell side of the hollow fiber module into a collection tank. The strip dispersion was allowed to stand until phase separation occurred. The aqueous solution phase, i.e., the concentrated gallium solution, was collected. The gallium concentration after recovery was measured as about 3 wt %. The gallium recovery rate was calculated to be about 99.8%, and the copper removal rate was calculated to be about 98.9%. The collected solution was electrolyzed to obtain high purity gallium metal (>4N).

### Example 6

Feed Solution (1 L) containing 4.5 wt % of copper and 1.5 wt % of gallium and being adjusted to an initial pH value of 1 by adding sodium hydroxide (NaOH)

Organic Solution=70% by volume D2EHPA, Isoparaffinic Solvent™, 1 L

Strip=3N HCl, 0.5 L

The experimental procedure for this example was the same as that described in Example 4 except that the 70 vol % D2EHPA was used instead of 30 vol %.

The procedure was stopped until the gallium concentration in the feed solution is less than 30 ppm, and the strip dispersion was drained from the shell side of the hollow fiber module into a collection tank. The strip dispersion was allowed to stand until phase separation occurred. The aqueous solution phase, i.e., the concentrated gallium solution, was collected. The gallium concentration after recovery was measured as about 3 wt %. The gallium recovery rate was calculated to be about 99.4%, and the copper removal rate was calculated to be about 99.5%. The collected solution was electrolyzed to obtain high purity gallium metal (>4N).

### Example 7

Feed Solution (1 L) containing 4.5 wt % of copper and 1.5 wt % of gallium and being adjusted to an initial pH value of 0.5 by adding sodium hydroxide (NaOH)

Organic Solution=50% by volume D2EHPA, in Isoparaffinic Solvent™, 1 L

Strip=3N HCl, 0.5 L

The experimental procedure for this example was the same as that described in Example 5 except that the feed solution was adjusted to an initial pH value of 0.5 instead of 1 by adding sodium hydroxide.

The procedure was stopped until the gallium concentration in the feed solution was less than 30 ppm, and the strip dispersion was drained from the shell side of the hollow fiber module into a collection tank. The strip dispersion was allowed to stand until phase separation occurred. The aqueous solution phase, i.e., the concentrated gallium solution, was collected. The gallium concentration after recovery was measured as about 3 wt %. The gallium recovery rate was calculated to be about 99.2%, and the copper removal rate was calculated to be about 99.9%. The collected solution was electrolyzed to obtain high purity gallium metal (>4N).

### Example 8

Feed Solution (1 L) containing 4.5 wt % of copper and 1.5 wt % of gallium and being adjusted to an initial pH value of 1.5 by adding sodium hydroxide (NaOH)

Organic Solution=50% by volume D2EHPA, in Isoparaffinic Solvent™, 1 L

Strip=3N HCl, 0.5 L

The experimental procedure for this example was the same as that described in Example 5 except that the feed solution was adjusted to an initial pH value of 1.5 instead of 1 by adding sodium hydroxide.

The procedure is stopped until the gallium concentration in the feed solution is less than 30 ppm, and the strip dispersion was drained from the shell side of the hollow fiber module into a collection tank. The strip dispersion was allowed to stand until phase separation occurred. The aqueous solution phase, i.e., the concentrated gallium solution, was collected. The gallium concentration after recovery was measured as about 3 wt %. The gallium recovery rate was calculated to be about 99.1%, and the copper removal rate was calculated to be about 98%. The collected solution was electrolyzed to obtain high purity gallium metal (>4N).

### Example 9

Feed Solution (1 L) containing 1.5 wt % of copper and 0.5 wt % of gallium and being adjusted to an the initial pH value of 1 by adding sodium hydroxide (NaOH)

Organic Solution=50% by volume D2EHPA, Isoparaffinic Solvent™, 1 L

Strip=3N HCl, 0.5 L

The experimental procedure for this example was the same as that described in Example 7 except that the feed solution was adjusted to an the initial pH value of 1 instead of 0.5, and the feed Solution containing 1.5 wt % of copper and 0.5 wt % of gallium were used instead of 4.5 wt % of copper and 1.5 wt % of gallium.

The procedure was stopped until the gallium concentration in the feed solution was less than 30 ppm, and the strip dispersion was drained from the shell side of the hollow fiber module into a collection tank. The strip dispersion was allowed to stand until phase separation occurred. The aqueous solution phase, i.e., the concentrated gallium solution, was collected. The gallium concentration after recovery was measured as about 1 wt %. The gallium recovery rate was calculated to be about 99.3%, and the copper removal rate was calculated to be about 96.9%. The collected solution was electrolyzed to obtain high purity gallium metal (>4N).

### Example 10

Feed Solution (1 L) containing 9 wt % of copper and 3 wt % of gallium and being adjusted to an initial pH value of 1 by adding sodium hydroxide (NaOH)

Organic Solution=50% by volume D2EHPA, in Isoparaffinic Solvent™, 1 L

Strip=3N HCl, 0.5 L

The experimental procedure for this example was the same as that described in Example 7 except that the feed Solution containing 9 wt % of copper and 3 wt % of gallium instead of 1.5 wt % of copper and 0.5 wt % of gallium.

The procedure was stopped until the gallium concentration in the feed solution was less than 30 ppm, and the strip dispersion was drained from the shell side of the hollow fiber module into a collection tank. The strip dispersion was allowed to stand until phase separation occurred. The aqueous solution phase, i.e., the concentrated gallium solution, was collected. The gallium concentration after recovery was measured as about 6 wt %. The gallium recovery rate was calculated to be about 99.9%, and the copper removal rate was calculated to be about 99.8%. The collected solution was electrolyzed to obtain.

### Example 11

Feed Solution (2 L) with 3000 ppm copper, 4000 ppm indium and 1000 ppm gallium

Organic Solution=50% by volume D2EHPA, in Isoparaffinic Solvent™, 1 L

Strip=3N HCl, 0.5 L

The feed solution was prepared by the following steps. First, waste material containing copper, indium and gallium was dissolved in hydrochloric acid. The resulted solution has a hydrochloric acid concentration of 4N determined by titration with 3M NaOH solution. Then, concentrated is hydrochloric acid was added until the hydrochloric acid concentration in the feed solution was at least 10N.

The experimental procedure for this example was the same as those described in the above examples except that the hydrochloric acid concentration in the feed Solution was adjusted to at least 10 N.

The procedure was stopped until the gallium concentration in the feed solution was less than 30 ppm, and the strip dispersion was drained from the shell side of the hollow fiber module into a collection tank. The strip dispersion was allowed to stand until phase separation occurred. The aqueous solution phase, i.e., the concentrated gallium solution, was collected. The gallium concentration after recovery was measured as about 4000 ppm. The gallium recovery rate was calculated to be about 99.1%, and the copper and indium removal rate were calculated to be about 99.9% and 99.7%, respectively. The copper and indium in the feed solution are not extracted by D2EHPA almost. Therefore, the feed solution containing the copper, indium and gallium has gradually altered into a feed solution containing the copper and indium. The strip solution phase contains the gallium. So far, the gallium was almost separated from the indium.

Although the present invention has been described in considerable detail with reference to certain embodiments thereof, their spirit and scope of the appended claims should not be limited to the description of the embodiments contained herein. Those skilled in the art should appreciate that they may readily use the present disclosure as a basis for designing or modifying other processes and structures for carrying out the same purposes and/or achieving is the same advantages of the embodiments introduced herein. In view of the foregoing, it is intended that the present invention cover modifications and variations of this invention provided they fall within the scope of the following claims.

What is claimed is:

1. A method for the removal and recovery of gallium from a feed solution containing the gallium and copper, the method comprising:
providing a supported liquid membrane (SLM) embedded in a microporous support material;
providing a strip dispersion by dispersing an aqueous strip solution in an organic liquid comprising an extractant;
adjusting the initial pH value of the feed solution to at most 3.5 or adding a concentrated acid to the feed solution such that the initial concentration of the acid in the feed solution is at least 10N;
treating the feed solution on one side of the SLM to selectively remove the gallium by the use of the strip dispersion on the other side of the SLM;
allowing the strip dispersion or a part of the strip dispersion to separate into an organic liquid phase and an aqueous strip solution phase, the aqueous strip solution phase containing a concentrated gallium solution.

2. The method of claim 1, wherein the microporous support material is a hollow fiber module comprising microporous hollow fibers arranged in a shell-and-tube configuration, the feed solution is passed through the tube side of the hollow fiber module, and the strip dispersion is passed through the shell side of the hollow fiber module.

3. The method of claim 1, wherein the volume of the organic liquid is larger than the volume of the aqueous strip solution in the strip dispersion.

4. The method of claim 3, wherein the volume ratio of the organic liquid to the aqueous strip solution in the strip dispersion is about 2:1.

5. The method of claim 2, wherein the feed solution further comprises indium (In) and is added with the concentrated acid such that the initial concentration of the acid in the feed solution is at least 10N.

6. The method of claim 5, wherein the copper and the indium has a higher concentration than the gallium in the feed solution.

7. The method of claim 1, wherein the copper has a higher concentration than the gallium in the feed solution.

8. The method of claim 1, wherein the initial pH value of the feed solution is adjusted to the range between 0.5 and 1.5.

9. The method of claim 1, wherein the microporous support material comprises a hydrophobic material.

10. The method of claim 9, wherein the hydrophobic material is selected from the group consisting of polypropylene, polytetrafluoroethylene, polyethylene, polysulfone, polyethersulfone, polyetheretherketone, polyimide, polyamide, polyaramide, and mixtures thereof.

11. The method of claim 10, wherein the hydrophobic material is polypropylene.

12. The method of claim 1, wherein the extractant is di(2-ethyl-hexyl)phosphoric acid (D2EHPA).

13. The method of claim 12, wherein the organic liquid comprises about 10% by volume to about 70% by volume of the di(2-ethyl-hexyl)phosphoric acid (D2EHPA).

14. The method of claim 13, wherein the organic liquid comprises about 30% by volume to about 50% by volume of the di(2-ethyl-hexyl)phosphoric acid (D2EHPA).

15. The method of claim 1, wherein the aqueous strip solution comprises an acid.

16. The method of claim 15, wherein the aqueous strip solution comprises hydrochloric acid.

17. The method of claim 16, wherein the equivalent concentration of the hydrochloric acid in the aqueous strip solution is from 1N to 6N.

18. The method of claim 17, wherein the equivalent concentration of the hydrochloric acid in the aqueous strip solution is 3N.
